(19) United States
(12) Patent Application Publication
(10) Pub. No.: US 2013/0185900 A1
(43) Pub. Date: Jul. 25, 2013

(54) Looped Bungee Strap Tie-Down with Locking Slide

(71) Applicant: Phillip R. Campbell, Maumelle, AR (US)

(72) Inventor: Phillip R. Campbell, Maumelle, AR (US)

(21) Appl. No.: 13/358,177

(22) Filed: Jan. 25, 2012

(51) Int. Cl. F16G 11/12

(52) U.S. Cl. 24/301

(57) ABSTRACT

A looped bungee cord fastener strap exerts extreme force to temporarily hold and restrain a variety of differently sized and shaped objects. An elongated cord has terminal ends restrained and shrouded within a spherical anchor that are integral with a spaced apart loop in the cord. The cord a two-piece spherical slide sized like the anchor formed from a pair of complementary halves. The cord extends through parallel passageways in the spherical slide, and when the cord is stretched, the slide can be displaced relative to the cord. Each slide passageway has a plurality of spaced-apart, internal nubs that frictionally contact the cord when it is unstretched to lock the slide and cord relative to each other. Surface segments adjacent the passageways in each slide half, and wall surfaces between passageways in each half, contact one another in assembly for strength.

### BACKGROUND OF THE INVENTION

1. Field of the Invention

The present invention relates generally to stretchable tie-downs cords. More particularly, the present invention relates to adjustable, looped, bungee-cord fasteners with slidable components. Known prior art of this general type is classified in United States Patent Class 24, Subclasses 115 and 136.

2. Description of the Related Art

A variety of bungee cords, tie-downs, and fastener straps are well known in the art. Some known straps include a pair of spherical elements, one comprising an anchor, and the other functioning as a slide, but hitherto these have been unreliable. Usually, after moderate use, the cord ceases to frictionally lock the slide, so the cord's efficiency is sacrificed.

U.S. Pat. No. 3,965,544 issued Jun. 29, 1976 discloses a slidable cord locking device Having a slide received within a tapered passage. A cord extends along a path between a locking portion of the slide and a side wall of the tapering body passage. The cord is gripped by a wedging action by a pair of arms when the cord is pulled longitudinally.

U.S. Pat. No. 4,221,024 issued Sep. 9, 1980 shows a storage apparatus for suspending articles, such as skis. Articles are suspended by means of an inter-looped strand which forms adjustable loops. A slide is used to adjust the loops and lock the article in place.

U.S. Pat. No. 4,288,891 issued Sep. 15, 1981 discloses a cord lock using a plunger that can be pressed inwardly against the resistance of an actuating spring to grip cords when the plunger is in a locking position.

U.S. Pat. No. 5,008,981 issued Apr. 23, 1991 illustrates a cord locking device forming a clasp for a bola-style necktie. Two mating shell halves and a manually operable spring biased clamp disposed between the shell halves provide a releasable clasp. Inner surfaces of the clasp engage the tie ends and clasp the tie ends around the periphery of the cord. Although firmly clasping the cord ends the clasp may be forced along the cord ends without manually releasing the clamp.

U.S. Pat. No. 5,245,730 issued Sep. 21, 1993 discloses a rope clamp with a pair of caps hingedly connected to opposite sides of a base. A longitudinally extending groove formed in each side of the base aligns with similar grooves in complementary caps so that a pair of longitudinally extending, rope-receiving cylindrical bores is formed. Upstanding spikes are positioned in each groove so that a rope in a bore is engaged by the spikes.

U.S. Pat. No. 5,283,930 Feb. 8, 1994 discloses a cord clamp with a hasp including two portions which form a clasp body, thereby capturing the folded cord therebetween. The portions include gripping teeth for defining a tortuous path for the cord.

U.S. Pat. No. 5,345,656 issued Sep. 13, 1994 discloses a mechanical cord lock forming a non-slipping loop in an elastic bungee cord. The connector includes two releasably engageable parts which. when mated, defines two tortuous paths through the connector parts which ensure that the elastic cord lengths that are placed therethrough in a stretched position remain in such position without slippage.

U.S. Pat. No. 5,572,770 issued Nov. 12, 1996 discloses a self locking cord lock including a cage containing a passage through which a cord or cords can extend, a slide body movable within the cage between a locking position for retaining the cord or cords against movement, and a spring yieldingly urging the slide body towards a locking position.

U.S. Pat. No. 6,618,910 issued Sep. 16, 2003 discloses a cord clamp having a housing with complementary, mating body portions establishing side-by-side cord accommodating passages extending through the housing. A plurality of cord retaining teeth protrudes into one of the passages. A hinge may interconnect the first and second body portions at one end thereof, preferably between the passages.

Notwithstanding the relatively abundant prior art, tie-downs having sliding components associated with bungee-type cords have hitherto demonstrated relative weak holding power. In order to provide a tie-down or robust fastening cord using slidable components and stretchable bungee cord, which demonstrates superior holding power, I have found that the slide components must be changed. In particular, for bungee cords or tie-downs the type including a spherical anchor and a spherical slide that is of sufficient strength to reliably hold diverse object, and which demonstrates enhanced holding power, it is important to redesign the internal channel structure of the slide in a manner which has hitherto been unknown.

### BRIEF SUMMARY OF THE INVENTION

The tie-down cord described herein has applications as a fastener device or bungee cord. It can be adapted for use with a large variety of differently sized and shaped objects. An elongated, looped elastic bungee cord has terminal ends anchored within a spherical anchor. The cord penetrates parallel passageways within a spherical slide, which can be displaced relative to the cord when the cord is stretched.

The preferably two piece slide comprises a mated pair of complementary halves, each shaped like a hemisphere. Parallel and spaced apart channels within each half register in assembly to form a pair of parallel passageways through which the cord extends. The diameter of each channel is less than the rest diameter of the cord; in other words, without stretching the cord, the cord's diameter exceeds the diameter of the slide passageways. Each channel and each passageway has a plurality of spaced-apart, internal nubs that frictionally contact the cord. The nubs frictionally engage the cord when the cord is relaxed to restrain the slide. Relaxation of the cord insures that the expanded cord diameter will contact the nubs, and the cord will be firmly, frictionally restrained within the slide. When the cord is longitudinally stretched, the resulting decreased cord diameter will relieve interference between the cord, the passageways, and the nubs, and movement of the slide will be facilitated.

Thus a basic object is to provide an easily adjustable bungee-type strap or tie-down for fastening various diverse articles or bundles of various miscellaneous items.

A related object is to provide an easily adjusted looped strap fastener of the character described.

Another important object is to provide a slide mechanism for looped fastener straps that quickly adjusts the loop and securely grasps and tensions it.

A related object is to provide a cord lock which is adapted to secure two portions of an elastic cord therein such that the cords portions remain in position without slippage during use.

Another object of the present invention is to provide a fastening strap with novel cord clamps comprising a two piece slide formed by first and second matable body portions that contain internal structure that controls cord displacement.

These and other objects and advantages of the present invention, along with features of novelty appurtenant thereto, will appear or become apparent in the course of the following descriptive sections.

### BRIEF DESCRIPTION OF THE SEVERAL VIEWS OF THE DRAWINGS

In the following drawings, which form a part of the specification and which are to be construed in conjunction therewith, and in which like reference numerals have been employed throughout wherever possible to indicate like parts in the various views:

FIG. 1 is an isometric view of the best mode of my invention, showing the fastener;

FIG. 2 is an isometric view showing the fastener engaging a bundle of miscellaneous items;

FIG. 3 is an enlarged. partially exploded, fragmentary, isometric view, with portions thereof omitted for brevity;

FIG. 4 is an enlarged, exploded isometric view of the slide, showing the interior of the male component;

FIG. 5 is an enlarged, exploded isometric view of the slide, showing the complementary female component in detail;

FIG. 6 is an enlarged, fragmentary, sectional view of the preferred anchor, taken generally along line 6-6 of FIG. 1;

FIG. 7 is an enlarged, fragmentary, sectional view of the preferred anchor, taken generally along line 7-7 of FIG. 3;

FIG. 8 is an enlarged end view of the locked slide, taken generally along line 8-8 of FIG. 1, showing the cord unstretched and captivated within the slide; and,

FIG. 9 is an enlarged end view of the adjustable slide similar to FIG. 8, but showing the cord stretched and loosely penetrating the slide;

FIG. 10 is an enlarged plan view of the slide's male component interior with the cord relaxed or unstretched; and,

FIG. 11 is an enlarged plan view of the slide's male component interior similar to FIG. 10, but showing the cord stretched or tensioned to enable slide movement.

### DETAILED DESCRIPTION OF THE INVENTION

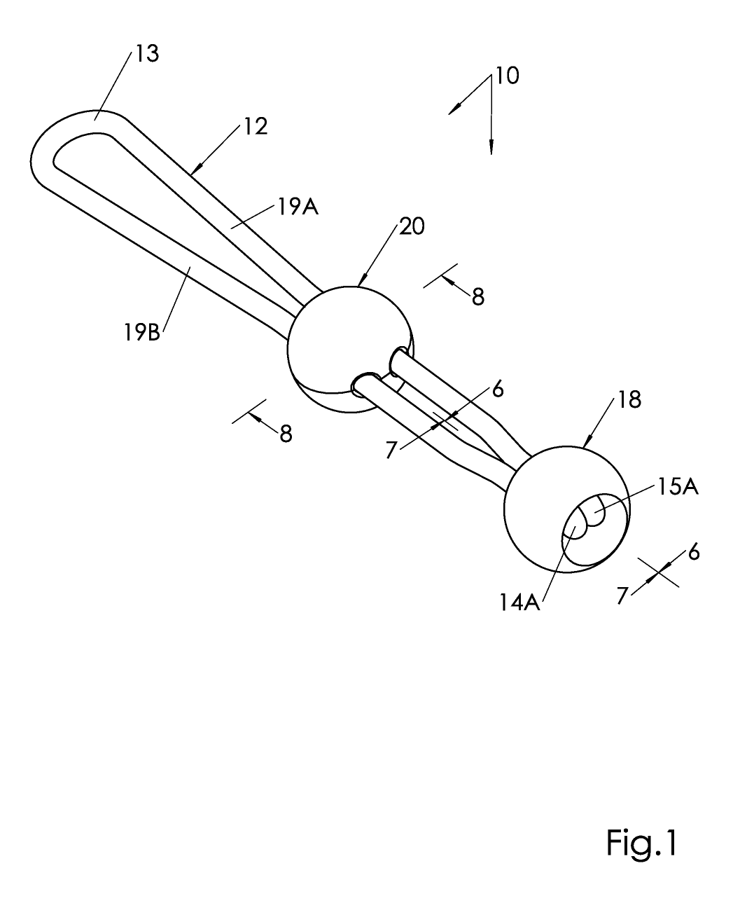

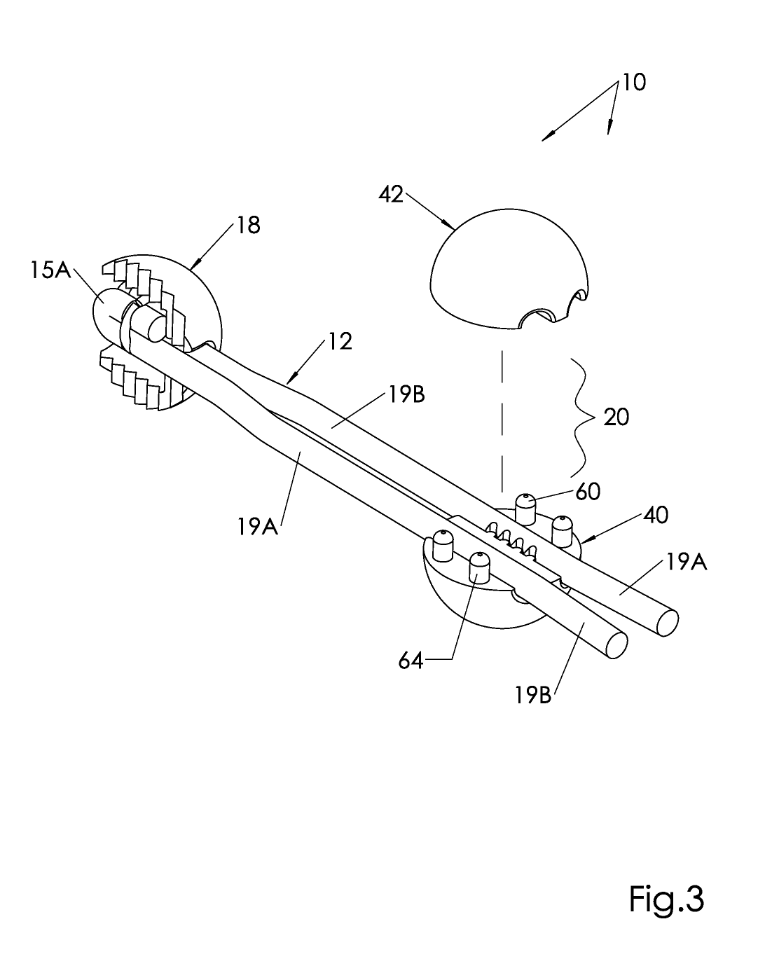

With initial reference directed to FIGS. 1-3 of the appended drawings, a looped bungee-cord type fastener constructed generally in accordance with the best mode of the invention has been generally designated by the reference numeral 10. The fastener 10 is user adjustable so it can be readily adapted for a variety of applications. It can be stretched to fit around a variety of differently sized items, and it can be used in various situations involving different dimensions.

Preferably, fastener 10 comprises an elongated, elastic bungee-type cord 12 that is folded at one end, forming a loop 13. The opposite terminal ends 14, 15 (FIG. 7) of the cord 12 form terminal anchor loops 14A, 15A that are secured and locked within a hollowed anchor 18, as explained in detail hereinafter. Parallel, elongated cord portions 19A, 19B of the cord 12 extend from the looped end 13 through an adjustable slide 20 to the ends 14 and 15 (FIG. 7).

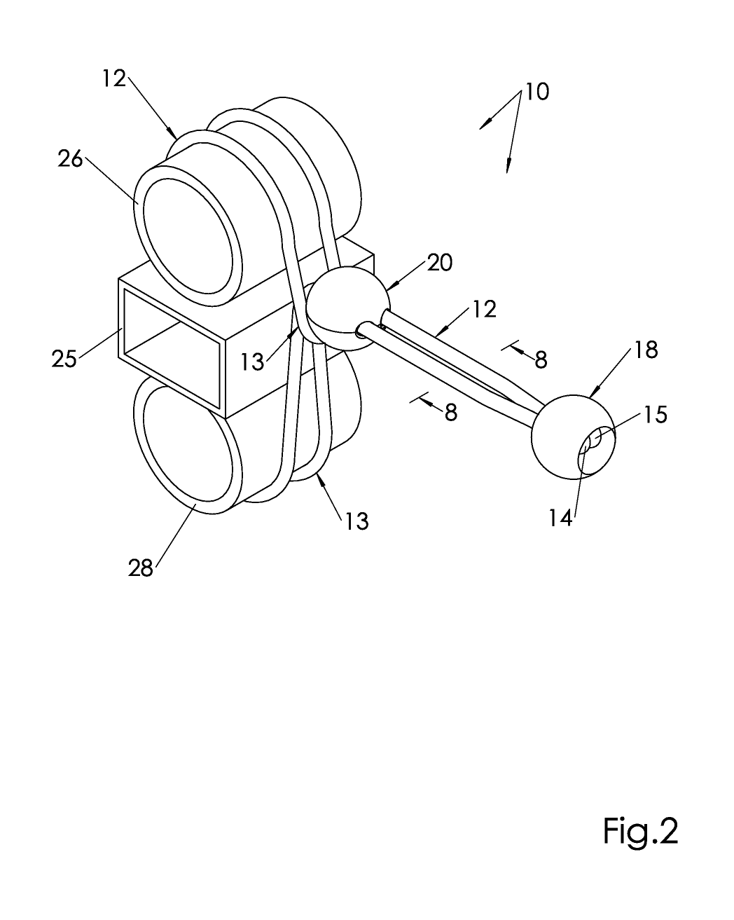

FIG. 2 illustrates generally how the cord can engage or restrain a variety of miscellaneous objects. For purposes of illustration only, the objects being held include a segment 25 of square tubing which is bounded by a pair of cylindrical pipe segments 26 and 28. To fasten such diverse objects, the cord 10 is stretched around the objects 25, 26 and 28. The looped portion 13, elongated by stretching, is pulled around and wrapped over the objects. The anchor 18 and the slide 20 are pulled through the looped end 13, which can be stretched or hand manipulated to configure the cord 10. While the cord is still stretched by grasping the anchor, the slide 20 is pulled towards the objects 25, 26 and 28, and the anchor 18 is pulled away as illustrated. Loop 13 is restrained by contact with the underside of the slide 20. When the cord 12 is released, the elastic cord body will increase in diameter, becoming captivated within locking structure defined within the slide 20, explained below. When so locked, and untensioned, the cord body 12 remains frictionally grasped within the slide 20, and relative movements between the slide 20 and the cord segments 12 passing through it are resisted.

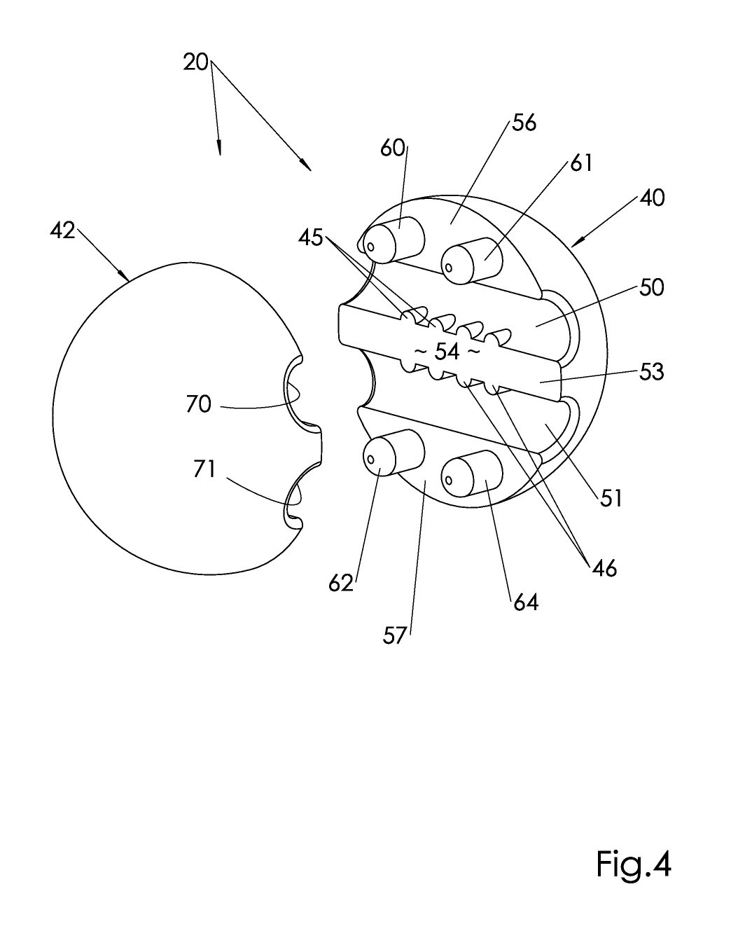

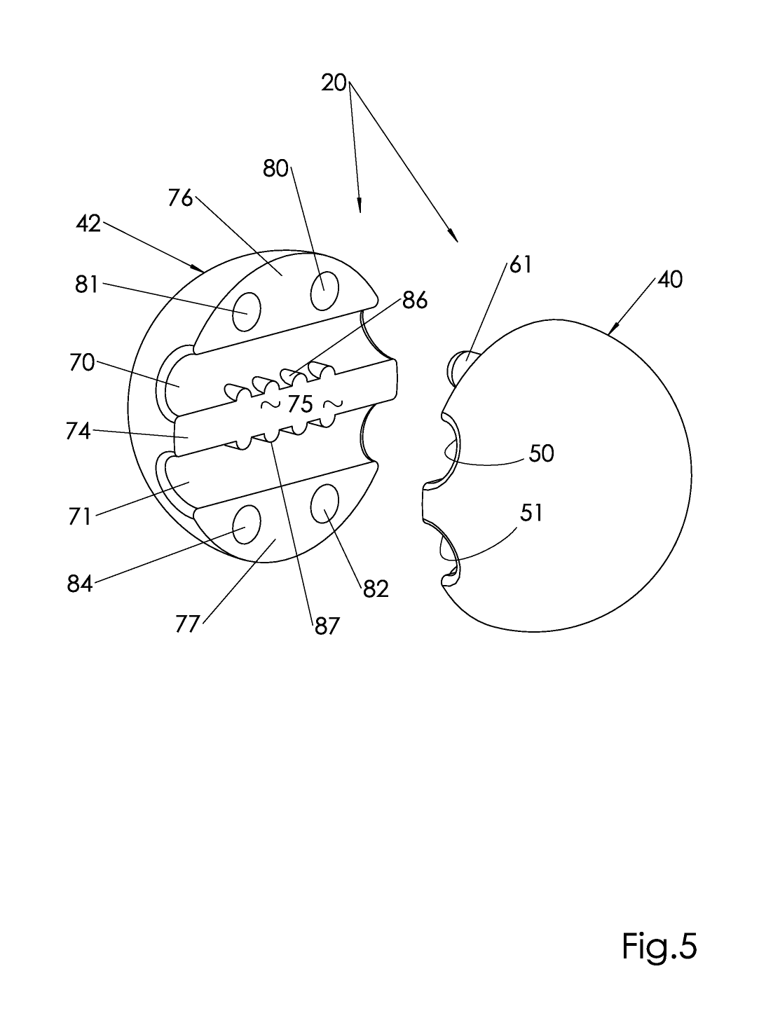

With additional reference now directed to FIGS. 4-5, slide 20 is in the form of a sphere, preferably comprising twin, complementary, substantially hemispherical halves 40 and 42. Preferably the two piece slide 20 is made of molded plastic, or materials such as wood. Slide 20 controls the cord 12 passing through it by internal structures provided by the assembled halves 40, 42. The male half 40 of the slide 20 is complementary to the female half 42, and in assembly these two parts snap fit together.

Inner portions of the slide's male half 40 are best seen in FIG. 4. Parallel and spaced apart channels 50 and 51 are disposed on opposite sides of a central wall 53. The channels 50, 51 and sized to tightly receive the cord 12 when it is unstretched, and to clear the cord when it is stretched. Channel 50 has a plurality (preferably four) of integral, spaced, apart friction nubs 45 that border wall 53. Similarly, channel 51 has four spaced-apart friction nubs 46 bordering wall 53 on the opposite side from channel 50. Nubs 46 and 45 are aligned with one another. Each nub 45, 46 is generally in the form of a sliced cylinder sunk into the walls of the respective channels 50, 51. Preferably the nubs are oriented perpendicular to the channels. The purpose of the nubs is to frictionally engage the cord 12 when the cord is relaxed or unstretched, and seated within channels 50 and 51.

Wall 53 has a flat, planar surface 54 forming the center of half 40. Nubs 45 and 46 are substantially perpendicular to surface 54 (FIG. 4). Surface 54 is coplanar with a pair of spaced part, segment-shaped surfaces 56, 57 bordering the wall 53. A pair of locking pins 60 and 61 project outwardly from surface 56. A pair of similar locking pins 62 and 64 project outwardly from surface 57.

As seen in FIG. 5, the female slide half 42 has a pair of elongated, parallel channels 70 and 71 separated by a wall 74. The generally rectangular surface 75 of wall 74 is coplanar with twin, segment-shaped surfaces 76 and 77. It will noted that segment 76 (FIG. 5) comprises a pair of orifices 80 and 81. Similarly, segment 77 has spaced apart orifices 82 and 84. Further, channels 70 and 71 both have plurality of spaced apart, integral nubs 86 and 87 respectively. Nubs 86 and 87 are similar to nubs 45 and 46 (FIG. 4) discussed above.

These complementary slide halves 40 and 42 reliably mate in assembly because of the pins that functions as guides. Pins 60, 61 (i.e., FIGS. 4, 5) register with and are glued within orifices 80, 81 (FIG. 5) respectively. Concurrently, pins 62 and 64 (FIG. 4) are seated and glued within orifices 82 and 84 (FIG. 5) respectively. Complementary channels 70 (FIG. 5) and 50 (FIG. 4), and complementary channels 71 and 51 register to form elongated, substantially tubular passageways through which portions of cord 12 extend in assembly. Surface 54 (FIG. 4) will abut surface 75 (FIG. 5). Furthermore, in assembly ends of nubs 45 will frictionally abut ends of nubs 86, and ends of nubs 46 (FIG. 4) will abut terminal ends of nubs 87.

Also in assembly the walls 54 and 75 will firmly abut one another for strength. The segment-shaped surfaces 56, 57 (i.e., FIG. 4) bordering the wall 53 will abut segments 76, 77 (i.e., FIG. 5) respectively.

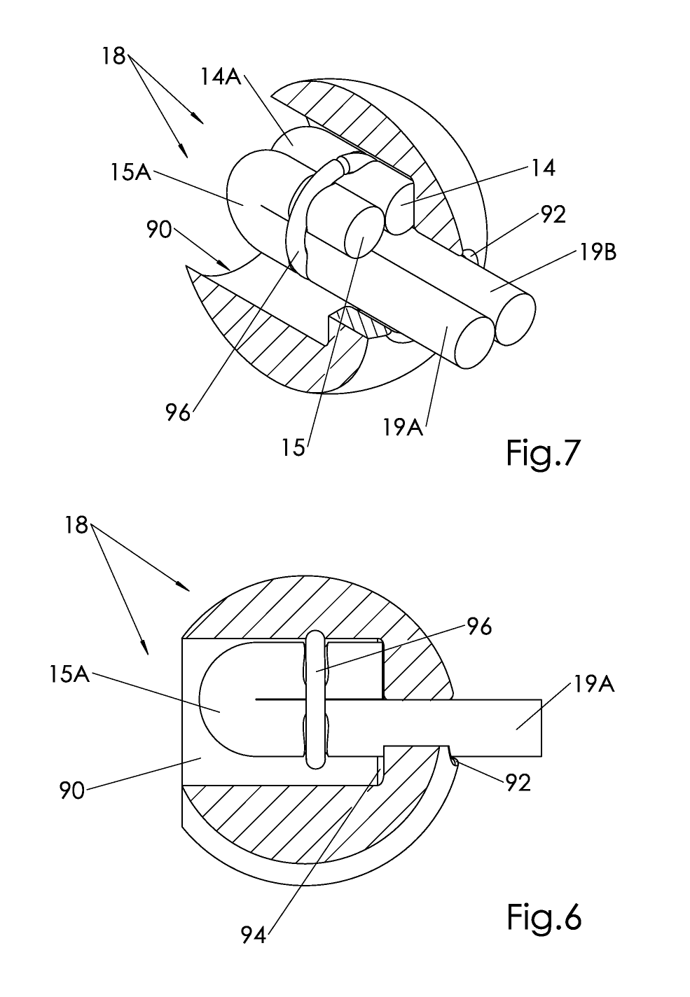

Referring primarily now to FIGS. 6 and 7, the anchor 18 preferably comprises a one piece sphere, made of wood or plastic. It's purpose is to cosmetically shroud the cord ends, and to provide a firm pulling point or handle for operation of the cord 10. The spherical anchor 18 has a relatively large diameter bore 90 at the left end (i.e., as viewed in FIG. 6) that communicates with a smaller bore 92 at the right end. A shoulder 94 is formed within the anchor, at the end of bore 90 The terminal anchor loops 15A and 14A are formed by the folded loop ends 14 and 15 that are secured together by a rigid, metallic clasp 96. The anchor loops 14A and 15A, bound within clasp 96, are seated within bore 90, with their cord ends 14, 15 abutting shoulder 94. The cord portions 19A and 19B extend outwardly of the anchor 18 though the smaller bore 92.

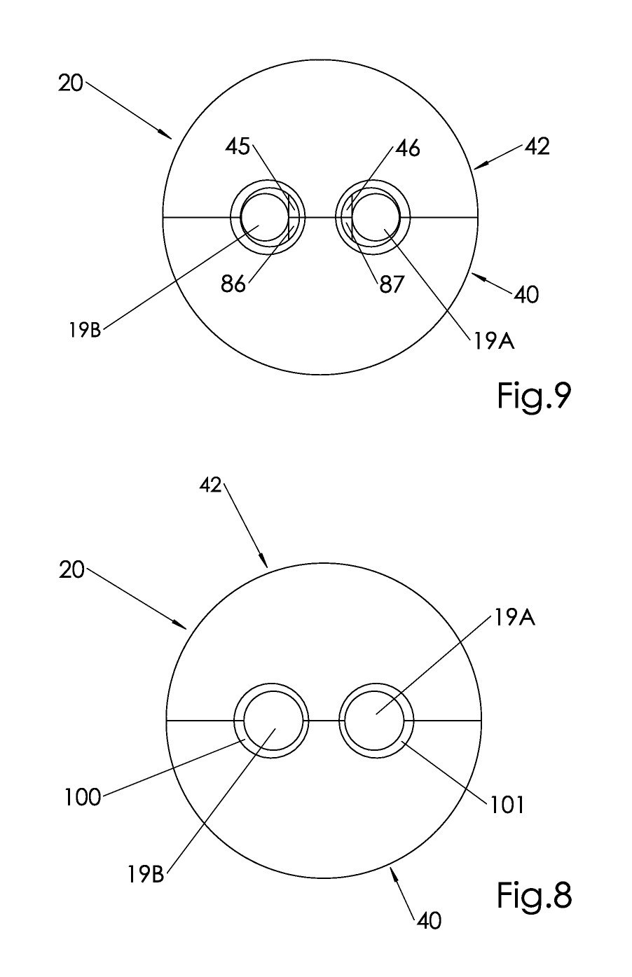

With reference now directed to FIGS. 8 and 9, when halves 40 and 42 are assembled, the aligned, complementary channels 50, 70 and 51, 71 align as aforesaid, resulting in the formation or twin, parallel cylindrical passageways 100, 101 (FIG. 8). These passageways are circular in cross section. The cord portions 19A and 19B are seen seated within the passageways. The cords are relaxed, or unstretched in FIG. 8, thus assuming their largest diameter, which is slightly less than the diameter of passageways 100, 101. The expanded cord segments block any view of the slider interior.

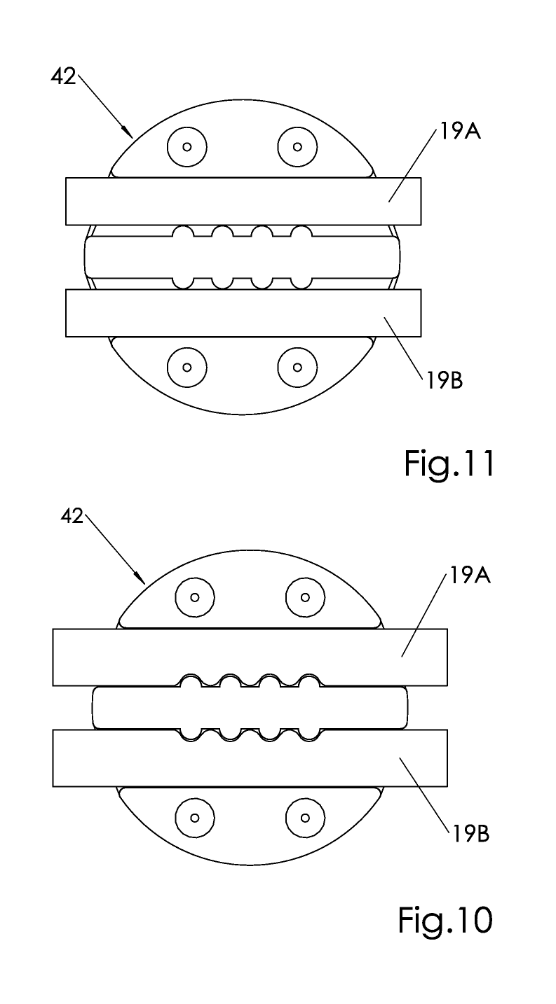

However, in FIG. 9 the cord 12 has been stretched, allowing slidable adjustments to slider 20. However, the cord segments 19A and 19B assume a smaller diameter, so that portions of the nubs 45, 46, 86 and 87 bordering the internal, parallel channels discussed earlier, are visible (FIG. 9). Viewing FIG. 11, with the cord still stretched, portions of these nubs are visible, with the stretched cord segments 19A and 19B just touching the cylindrical nub surfaces. When the cord is relaxed, the diameter of the cord expands. At this time the cord body expands in diameter, compressing against the various adjacent nubs (i.e., FIGS. 8, 10) within the channels or passageways. The cord is thus restrained within the slide 20, which will take substantial force to move. However, once the cord is stretched, the slide 20 can move along the cord relatively easily.

From the foregoing, it will be seen that this invention is one well adapted to obtain all the ends and objects herein set forth, together with other advantages which are inherent to the structure.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the accompanying drawings is to be interpreted as illustrative and not in a limiting sense.

What is claimed is:

1. An elastic tie-down comprising:
an elongated, elastic cord of bungee material having a folded loop at one end, and a pair of spaced-apart terminal ends;
an anchor in which the terminal ends of said cord are secured;
a slide penetrated by the cord, the slide comprising:
a first half comprising a first pair of spaced apart channels;
a second half that is adapted to be coupled to said first half, the second half comprising a second pair of spaced apart channels that register in assembly with said first pair of spaced apart channels to form a pair of parallel passageways within the slide;
wherein portions of said cord penetrate said passageways within said slide;
a plurality of generally cylindrical nubs perpendicularly formed in said channels for abutting the cord passing through said passageways; and,
whereby the slide locks to the cord by friction with said nubs when the cord is unstretched or relaxed, and the slide is free to move relative to the cord when the cord is stretched or tensioned.

2. The fastener as described in claim 1 wherein the slide is two piece, and comprises a pair of generally hemispherical, complementary halves that are mated together in assembly.

3. The fastener as described in claim 2 wherein a first slide half comprises locking pins projecting outwardly therefrom, and wherein a second slide half comprises receptive orifices for receiving said pins when said halves are mated together to form said slide.

4. The fastener as described in claim 2 wherein a first slide half comprises a pair of spaced apart, parallel channels, segment shaped surfaces adjacent said channels, pairs of locking pins projecting outwardly from each segment shaped surface, and wherein a second slide half comprises a pair of complementary channels, segment shaped surfaces adjacent said of said last mentioned channels, and a pair of receptive orifices disposed in said last mentioned segment shaped surfaces adjacent each of said complementary channels for receiving said pins when said halves are mated together to form said slide.

5. The fastener as described in claim 4 wherein said slide comprises a first wall between said slide channels with a wall surface, said anchor comprises a second wall between its channels with a second wall surface, and said first and second wall surfaces abut and mate in assembly for strength.

6. The fastener as described in claim 2 wherein the anchor comprises a bore in which cord terminal ends are captivated.

7. The fastener as described in claim 6 wherein each terminal end of the cord is secured together in a loop by a clasp that is restrained by a shoulder within said bore.

8. A stretchable tie-down strap comprising:
an elongated, elastic bungee cord comprising a folded loop at one end, and a pair of spaced-apart terminal ends;
said elastic cord having a first diameter at rest when it is unstretched and a second diameter when tensioned or stretched, the second diameter being less than said first diameter;
an anchor in which the terminal ends of said cord are secured;
a slide penetrated by the cord, the slide comprising:
a first half comprising a first pair of spaced apart channels;
a second half that is adapted to be coupled to said first half, the second half comprising a second pair of spaced apart channels that register in assembly with said first pair of spaced apart channels to form a pair of parallel passageways within the slide;
said parallel passageways having a diameter that is less than said first cord diameter;
wherein portions of said cord occupy said passageways within said slide;
a plurality of generally cylindrical nubs perpendicularly formed in said channels for abutting the cord passing through said passageways; and,
whereby the slide locks to the cord by friction with said nubs when the cord is unstretched or relaxed, and the slide is free to move relative to the cord when the cord is stretched or tensioned.

9. The strap as described in claim 8 wherein the anchor comprises a bore in which cord terminal ends are captivated.

10. The strap as described in claim 9 wherein each terminal end of the cord is secured together in a loop by a clasp that is restrained by a shoulder within said bore.

11. The strap as described in claim 8 wherein the slide is two piece, and comprises a pair of generally hemispherical, complementary halves that are mated together in assembly.

12. The strap as described in claim 11 wherein a first slide half comprises locking pins projecting outwardly therefrom, and wherein a second slide half comprises receptive orifices for receiving said pins when said halves are mated together to form said slide.

13. The strap as described in claim 11 wherein a first slide half comprises a pair of spaced apart, parallel channels, segment shaped surfaces adjacent said channels, pairs of locking pins projecting outwardly from each segment shaped surface, and wherein a second slide half comprises a pair of complementary channels, segment shaped surfaces adjacent said of said last mentioned channels, and a pair of receptive orifices disposed in said last mentioned segment shaped surfaces adjacent each of said complementary channels for receiving said pins when said halves are mated together to form said slide.

14. The strap as described in claim 13 wherein said slide comprises a first wall between said slide channels with a wall surface, said anchor comprises a second wall between its channels with a second wall surface, and said first and second wall surfaces abut and mate in assembly for strength.

15. The strap as described in claim 14 wherein the anchor comprises a bore in which cord terminal ends are captivated.

16. The strap as described in claim 15 wherein each terminal end of the cord is secured together in a loop by a clasp that is restrained by a shoulder within said bore.
